(19) United States
(12) Patent Application Publication
(10) Pub. No.: US 2008/0289233 A1
(43) Pub. Date: Nov. 27, 2008

(54) Swinging decoration of wind exit

(76) Inventors: Chien-Tsai Lee, Hsing-Juang City (TW); Rung-Chuen Lee, Hsing-Juang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,972

(22) Filed: Jul. 31, 2008

Related U.S. Application Data
(63) Continuation-in-part of application No. 11/455,770, filed on Jun. 20, 2006.

(30) Foreign Application Priority Data
Sep. 14, 2007 (TW) 096215446

(51) Int. Cl. G09F 19/08

(52) U.S. Cl. 40/412

(57) ABSTRACT

A swinging decoration of wind exit, including: a main body having a wind passage. A fan rotatably connected with the main body and disposed in the wind passage thereof. At least one swinging member pivotally mounted on the main body, the swinging member having a driven section. A driving cam plate fitted on a rotary shaft of the fan and rotatable along with the fan. The driving cam plate serves to drive the driven section of the swinging member and swing the swinging member to simulate swinging movement of an insect's wings.

### CROSS-REFERENCE TO RELATED APPLICATION

This application is a Continuation-in-Part Application of U.S. patent application Ser. No. 11/455,770, entitled “SWINGING DECORATION OF WIND EXIT”, filed on 20 Jun. 2006, now pending.

### BACKGROUND OF THE INVENTION

1. Field of the Invention

The present invention is related to a swinging decoration of wind exit, including a fan, a driving cam plate rotationally drivingly connected with the fan, and at least one swinging member having a driven section drivingly connected with the driving cam plate. When the driving cam plate is rotationally driven by the fan, the driving cam plate drives the driven section of the swinging member and swing the swinging member to simulate swinging movement of an insect's wings.

2. Description of the Prior Art

In general, the wind exit of a conventional indoor air-conditioner, a fan or a car air-conditioner has a guide grille including multiple wind-guiding slats. When the air-conditioner is actuated, the wind blows out of the wind exit through the guide grille thereof. The conventional guide grille has monotonous configuration without beautified pattern. Various wind exit decorations have been developed. A wind exit decoration can clip a wind-guiding slat of the guide grille for decorating/beautifying the wind exit. The wind exit decoration is often configured as a helicopter. Such wind exit decoration can clip a guide grille of a wind exit of a car air-conditioner. When the air-conditioner is actuated to blow wind from the wind exit, the wind can drive and rotate the propeller of the helicopter to simulate the flight of a true helicopter. Such wind exit decoration can simply simulate the flight of the helicopter, while is unable to simulate any otherwise movement such as swinging movement of a natural creature. Therefore, the application range of such wind exit decoration is quite narrow.

### SUMMARY OF THE INVENTION

It is therefore a primary object of the present invention to provide a swinging decoration of wind exit, including: a main body having a wind passage; a fan rotatably connected with the main body and disposed in the wind passage thereof; at least one swinging member pivotally mounted on the main body, the swinging member having a driven section; and a driving cam plate fitted on a rotary shaft of the fan and rotatable along with the fan. The driving cam plate serves to drive the driven section of the swinging member and swing the swinging member to simulate swinging movement of an insect's wings.

The present invention can be best understood through the following description and accompanying drawings wherein:

### BRIEF DESCRIPTION OF THE DRAWINGS

FIG. 1 is a perspective exploded view of a first embodiment of the present invention;

FIG. 2 is a perspective assembled view of the first embodiment of the present invention;

FIG. 3 is a perspective assembled view of the first embodiment of the present invention, seen from another angle;

FIG. 4 is a perspective assembled view of the first embodiment of the present invention according to FIG. 3, in which the resilient clip member is positioned in a horizontal state;

FIG. 5 is a plane view of the first embodiment of the present invention;

FIG. 6 is a plane view of the first embodiment of the present invention according to FIG. 5, showing the swinging movement of the swinging members; and

FIG. 7 is a plane view of a second embodiment of the present invention.

### DETAILED DESCRIPTION OF THE PREFERRED EMBODIMENTS

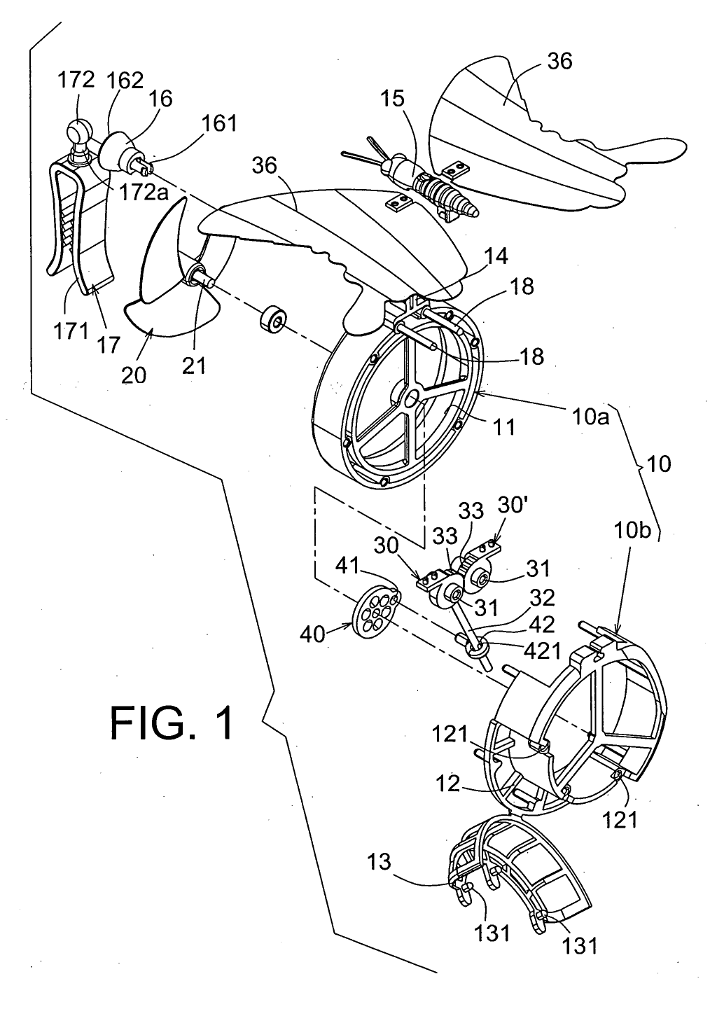

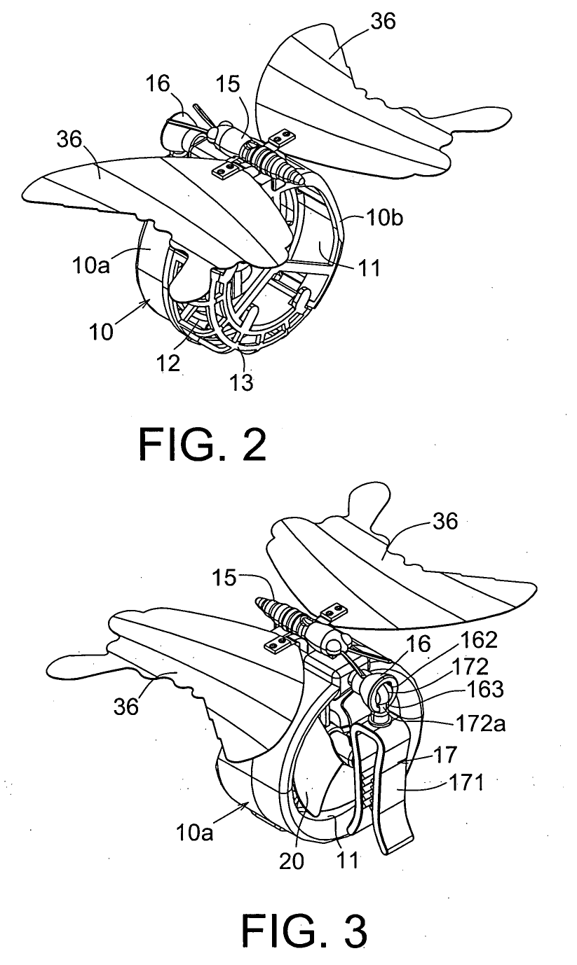

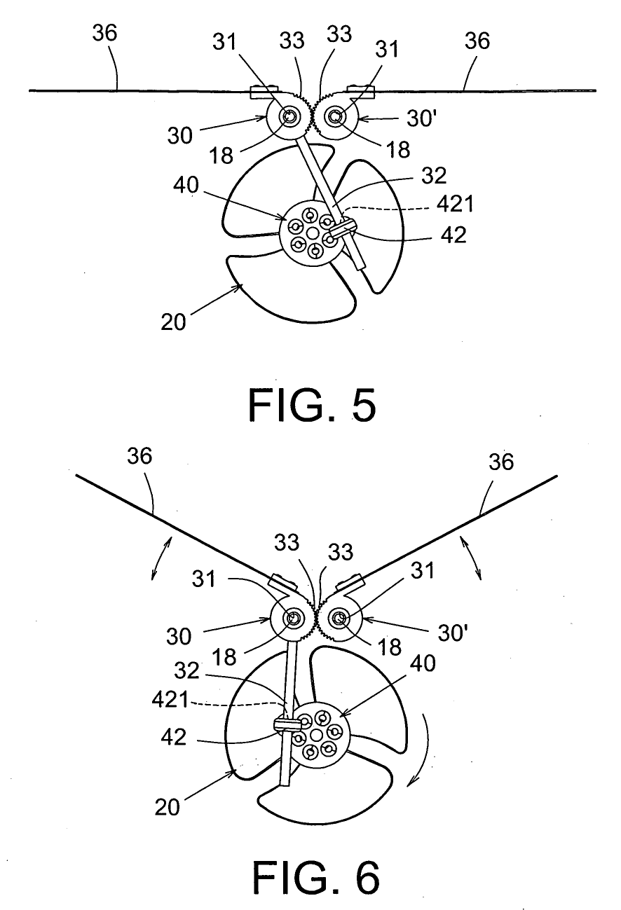

Please refer to FIGS. 1 to 6. The swinging decoration of wind exit of the present invention includes: a main body 10 having a wind passage 11; a fan 20 rotatably connected with the main body 10 and disposed in the wind passage 11 thereof; at least one swinging member 30 pivotally mounted on the main body 10 and a driving cam plate 40 fitted on a rotary shaft 21 of the fan 20 and rotatable along with the fan 20. The driving cam plate 40 serves to drive a driven section 32 of the swinging member 30 and swing the swinging member 30 to simulate swinging movement of an insect's wings.

The main body 10 is composed of a first casing 10a and a second casing 10b mated with each other. A circumference of the second casing 10b is provided with an incense receptacle 12. A cover body 13 is connected with an edge of the incense receptacle 12. The cover body 13 has a first latch section 131, while the incense receptacle 12 has a corresponding second latch section 121. The cover body 13 can be turned toward an exit of the incense receptacle 12 to close the exit. At this time, the first latch section 131 of the cover body 13 is latched with the second latch section 121 to hinder the incense (not shown) positioned in the incense receptacle 12 from dropping out.

An outer circumference of the main body 10 has an engaging seat 14 projecting therefrom. A decoration body 15 is engaged with the engaging seat 14. The decoration body 15 can be configured as a butterfly, a bee, a bird, etc. The configuration of the decoration body 15 is not limited to any specific shape.

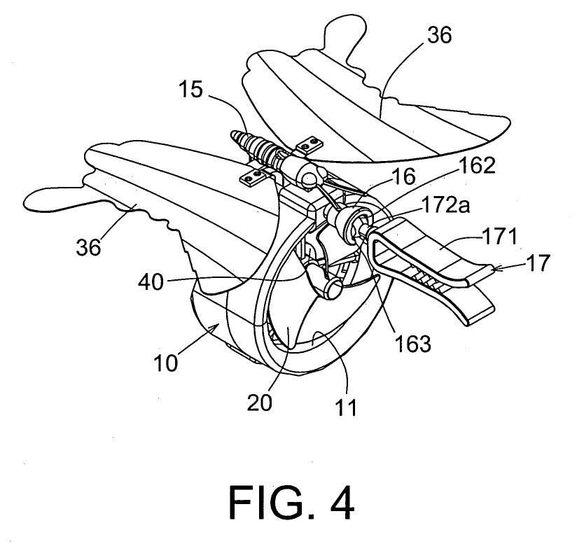

Please refer to FIGS. 1 to 4. The wind outlet swinging decoration of the present invention further includes a connecting seat 16 having an insertion pin 161 at one end. The insertion pin 161 is connected with a wind inlet side of the main body 10. A resilient clip member 17 is connected with the other end of the connecting seat 16 for tightly clipping a fixed article such as a wind exit of an air-conditioner (not shown). The resilient clip member 17 has a pair of resilient clip arms 171 extending from a first side of the resilient clip member 17 for tightly clipping the fixed article. The resilient clip member 17 further has a joint head section 172 protruding from a second side of the resilient clip member 17. The connecting seat 16 has a socket 162 in which the joint head section 172 is universally rotatably received in the socket 162. Accordingly, the direction of the main body 10 is universally adjustable relative to the connecting seat 16. Preferably, the fan 20 of the main body 10 can be right aligned with the wind exit of the air-conditioner and directed in a wind blowing direction thereof. Under such circumstance, the fan 20 can be easily driven by the wind. A bottom end of the connecting seat 16 is formed with a radial notch 163 in which a journal 172a of the joint head section 172 can be positioned. Accordingly, the resilient clip member 17 can be freely turned, for example, into a vertical state as shown in FIG. 3 or a horizontal state as shown in FIG. 4.

Please refer to FIGS. 1, 5 and 6. The swinging decoration of the wind exit of the present invention includes a pair of swinging members 30, 30′ each having a shaft hole 31. The main body 10 has two rotary shafts 18 fitted in the shaft holes 31 respectively. One swinging member 30 has a driven section 32 drivingly connected with the driving cam plate 40. Each of the swinging members 30, 30′ has a toothed face 33 centered at the shaft hole 31. The toothed faces 33 of the swinging members 30, 30′ are engaged with each other to rotationally drivingly engage the swinging members 30, 30′ with each other.

The driving cam plate 40 has an eccentric pivot hole 41. A fitting seat 42 is pivotally fitted in the pivot hole 41 on a first side of the driving cam plate 40. The fitting seat 42 has a slide hole 421 through which the driven section 32 of the swinging member 30 is snugly fitted. Accordingly, when the driving cam plate 40 is rotated along with the fan 20, the fitting seat 42 drives the driven section 32 of the swinging member 30. At this time, the swinging members 30, 30′ reciprocally swing.

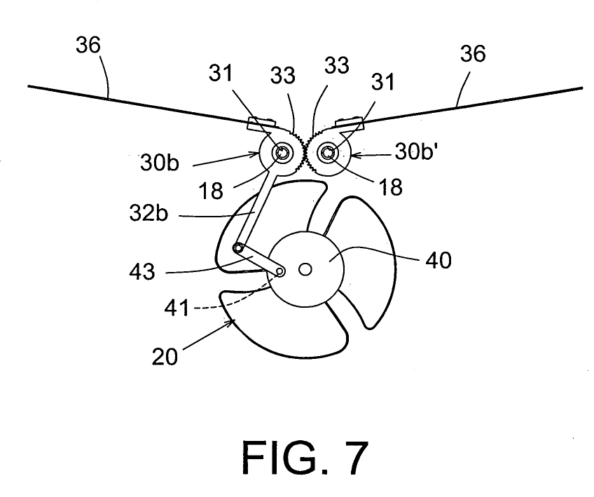

FIG. 7 shows a second embodiment of the swinging decoration of the wind exit of the present invention, in which the driving cam plate 40 has an eccentric pivot hole 41. A first end of a link 43 is pivotally connected in the pivot hole 41 on a first side of the driving cam plate 40. A second end of the link 43 is pivotally connected with the driven section 32b of the swinging member 30b. Accordingly, when the driving cam plate 40 is rotated along with the fan 20, via the link 43, the driven section 32 of the swinging member 30b is driven. At this time, the swinging members 30, 30′ reciprocally swing. By means of the link 43 connected between the driven section 32b and the driving cam plate 40, the swinging members 30, 30′ can swing within a wider range of angle.

In the swinging decoration of the wind exit of the present invention, the driving cam plate 40 is rotationally driven by the fan 20 to further drive the swinging members 30, 30′. The number of the components of the swinging decoration is reduced and the cost for the swinging decoration is lowered. In addition, the swinging decoration can swing more smoothly without dead point of movement.

The above embodiments are only used to illustrate the present invention, not intended to limit the scope thereof. Many modifications of the above embodiments can be made without departing from the spirit of the present invention.

What is claimed is:

1. A swinging decoration of wind exit, comprising:
(a) a main body having a wind passage;
(b) a fan rotatably connected with the main body and disposed in the wind passage thereof;
(c) at least one swinging member pivotally mounted on the main body, the swinging member having a driven section; and
(d) a driving cam plate fitted on a rotary shaft of the fan and rotatable along with the fan, the driving cam plate serving to drive the driven section of the swinging member to swing the swinging member.

2. The swinging decoration of the wind exit as claimed in claim 1, wherein a circumference of the main body is provided with an incense receptacle, a cover body being connected with an edge of the incense receptacle, the cover body having a first latch section, while the incense receptacle having a corresponding second latch section, whereby the cover body can be turned toward an exit of the incense receptacle to close the exit with the first latch section latched with the second latch section to hinder an incense positioned in the incense receptacle from dropping out.

3. The swinging decoration of the wind exit as claimed in claim 1, further comprising a connecting seat having an insertion pin at one end, the insertion pin being connected with a wind inlet side of the main body, a resilient clip member being connected with the other end of the connecting seat, the resilient clip member having a pair of resilient clip arms extending from a first side of the resilient clip member, the resilient clip member further having a joint head section protruding from a second side of the resilient clip member, the connecting seat having a socket in which the joint head section is rotatably received, the connecting seat being formed with a radial notch in which a journal of the joint head section can be positioned.

4. The swinging decoration of the wind exit as claimed in claim 1, wherein the wind outlet swinging decoration includes a pair of swinging members each having a shaft hole, the main body having two rotary shafts fitted in the shaft holes respectively, one of the swinging members having a driven section drivingly connected with the driving cam plate, each of the swinging members having a toothed face centered at the shaft hole, the toothed faces of the swinging members being engaged with each other to rotationally drivingly engage the swinging members with each other.

5. The swinging decoration of the wind exit as claimed in claim 1, wherein the driving cam plate has an eccentric pivot hole, a fitting seat being pivotally fitted in the pivot hole on a first side of the driving cam plate, the fitting seat having a slide hole through which the driven section of the swinging member is snugly fitted.

6. The swinging decoration of the wind exit as claimed in claim 1, wherein the driving cam plate has an eccentric pivot hole, a first end of a link being pivotally connected in the pivot hole on a first side of the driving cam plate, a second end of the link being pivotally connected with the driven section of the swinging member.
